(19) United States
(12) Patent Application Publication
(10) Pub. No.: US 2012/0051739 A1
(43) Pub. Date: Mar. 1, 2012

(54) Identifying a Characteristic of a Mesh Network

(76) Inventors: Marc Stephens, West Midlands (GB); Hayden Scott Fews, New South Wales (GB); Liam Gleeson, Warwickshire (GB); Michal Dlubek, Rzeszow (PL)

(21) Appl. No.: 13/141,299

(22) PCT Filed: Jan. 7, 2009
(86) PCT No.: PCT/EP2009/050130

§ 371 Date: Nov. 7, 2011

(30) Foreign Application Priority Data
Dec. 22, 2008 (EP) 08172632.5

(51) Int. Cl. H04B 10/08

(52) U.S. Cl. 398/25

(57) ABSTRACT

A method and apparatus for identifying at least one characteristic of at least one optical link of an optical network. The method comprises modulating a predetermined optical channel with a predetermined frequency component, and transmitting the modulated predetermined optical channel onto an optical waveguide at a predetermined power such that at least one optical data channel co-propagating along the optical waveguide with the modulated predetermined optical channel is modulated with the predetermined frequency component.

### TECHNICAL FIELD

The present invention relates in general to optical communication networks and in particular to a method and system for identifying and transmitting a characteristic of an optical link in a communications network.

### BACKGROUND

Wavelength division multiplexing (WDM) is an important technique for utilising the enormous bandwidth of optical fibre by concurrently transmitting a multiple number of individual channels at discrete wavelengths of light over fibre links of different lengths. The system architecture is typically bidirectional which means that a given terminal node will transmit in one direction and receive from the other. Current point to point systems of this type are commissioned with links consisting of all the same fibre type—for example, fibre made in compliance with the recommendation ITU-T G.652—Characteristics of a single-mode optical fibre and cable (“G652”) or fibre in compliance with ITU-T G.655—Characteristics of a non-zero dispersion-shifted single-mode optical fibre and cable (“G655”). The transmission history of the individual channels in this case is easily determined as all channels are generally transmitted over the same fibre type and cannot be rerouted in different directions. This means that the system can be set up specifically for that particular fibre type at the commissioning stage and left to operate through its lifetime with no major changes in performance.

More recently however, functionality is being increased above and beyond basic point-to-point communication by incorporating all-optical adding, dropping and rerouting of individual wavelength channels at specified nodes in the network. At present, these rerouting functions are typically performed manually via a software interface with the system (e.g. Local Craft Terminal), but recent progress in the field has shown automatic reconfigurability of transmission routes through a network based on demand to be a key performance improvement of future all-optical networks. This is termed an Automatically Switched Optical Network (ASON). Individual wavelengths of, for example, an 80 wavelength system have the potential to be sent through highly varied routes of the same network, seeing different fibre types, attenuations and dispersion.

The different fibre-types (and hence routes) have very different transmission characteristics in terms of: (i) Chromatic dispersion, and dispersion slope; (ii) Attenuation profile; (iii) Polarization mode dispersion (PMD); and (iv) Fibre core size, and hence susceptibility to fibre nonlinearities. Also, different routes will never be exactly the same length. This difference in propagation distance, coupled with the four main effects listed above means that the optical signal to noise ratio, residual dispersion and eye diagram quality at the eventual terminating receiver are critically dependent on the route taken. To allow the receiver to be able to appropriately deal with any variation or signal changes knowledge of the route taken is therefore particularly important for ASON networks.

One technique used to identify individual wavelengths within a WDM system is the use of Pilot Tones. A pilot tone is a small signal modulation of the data stream amplitude at a much lower frequency than the data itself. Such pilot tones are used to identify individual data channels on a per wavelength basis by modulating each optical carrier (individual wavelength) with an additional sub-carrier signal at the transmitter. Upgrading a system to use pilot tones can thus require the upgrade of each transmitter of each optical carrier, a relatively costly, and labour intensive operation, which is also undesirable as it normally requires traffic to be interrupted whilst each transmitter is upgraded.

Any discussion of documents, acts or knowledge in this specification is included to explain the context of the invention. It should not be taken as an admission that any of the material forms part of the prior art base or the common general knowledge in the relevant art.

### SUMMARY

According to a first aspect, the present invention provides a method for identifying at least one characteristic of at least one optical link of an optical network. The method comprises modulating a predetermined optical channel with a predetermined frequency component. The modulated predetermined optical channel is then transmitted onto an optical waveguide of an optical link at a predetermined power such that at least one optical data channel co-propagating along the optical waveguide with the modulated predetermined optical channel is modulated with the predetermined frequency component.

Such a technique, in which a predetermined optical channel is modulated with a predetermined frequency component, and then used to modulate a co-propagating optical data channel with the predetermined frequency component, allows the link to be upgraded relatively easily to provide apparatus for identifying the link. Further, the predetermined frequency component may be applied to all optical data channels on a link simultaneously, using only a single predetermined optical channel appropriately modulated with a predetermined frequency component.

The at least one optical data channel may be modulated with the predetermined frequency component by the physical process of stimulated Raman scattering. Said at least one optical data channel may further comprise a plurality of optical data channels, each one of the plurality of optical data channels being modulated with the predetermined frequency component. The predetermined frequency component may be indicative of the identity of at least one of: the optical link; an add/drop node coupled to said optical link; and an optical element coupled to said optical link, through which the at least one optical data channel propagates. The network may comprise a plurality of optical links, the method comprising repeating said modulating and transmitting steps for each of said plurality of optical links, with each optical data channel being modulated with a different predetermined frequency component for each optical link. The frequency of each predetermined frequency component may be within the range of 200 MHz to 700 MHz and optionally or preferably within the range of 400 MHz to 600 MHz. The optical data channel may be modulated with the predetermined frequency component by amplitude modulation. The predetermined optical channel may be an optical supervisory channel for carrying supervisory information. A wavelength separation between said predetermined optical channel and the at least one optical data channel may be within the range of 90 nm to 100 nm. The modulated predetermined optical channel may be transmitted at a power of at least 5 dBm. The optical waveguide may be an optical transmission fibre extending between two nodes of said network. The method may further comprise receiving at least one optical data channel and measuring at least one predetermined frequency component modulating the received at least one optical data channel for determining the route history of said at least one optical data channel.

In accordance with a further aspect, the present invention provides an apparatus for an optical network for identifying at least one characteristic of at least one optical link of an optical network. The apparatus comprises a modulator for modulating a predetermined optical channel with a predetermined frequency component. A coupler for transmitting the modulated predetermined optical channel onto an optical waveguide of an optical link at a predetermined power such that at least one optical data channel co-propagating along said optical waveguide with the modulated predetermined optical channel is modulated with said frequency component.

Such an apparatus can be arranged to provide a cost advantage over the current state of the art, by applying a predetermined frequency component to all optical data channels on a link in an optical network simultaneously from one predetermined optical channel. Thus, only the apparatus is required to modulate the predetermined optical channel with a predetermined frequency component, rather than separate apparatus for modulating each data channel. For an 80 channel optical network for example, this cost could be significant. A further advantage of this type of apparatus is that it can be non-traffic affecting for existing optical networks, by simply providing the apparatus for each link for modulating a predetermined optical channel with a predetermined frequency component, rather than having to alter the apparatus for each data channel.

The modulator may be tuneable to provide a different predetermined frequency component for different optical links. The frequency of the predetermined frequency component may be within the range of 200 MHz to 700 MHz and optionally or preferably 400 MHz to 600 MHz. The predetermined optical channel may be an optical supervisory channel for carrying supervisory information. A wavelength separation between said predetermined optical channel and the at least one optical data channel may be within the range of 90 nm to 100 nm. A generator may be arranged to generate the predetermined optical channel at a power of at least 5 dBm. The apparatus may further comprise a receiver for receiving at least one optical data channel and for measuring at least one predetermined frequency component modulating the received at least one optical data channel for determining the route history of said at least one optical data channel.

For a better understanding of the present invention, its operation, advantages and specific objects attained by its use, reference should be had to the accompanying drawings and descriptive matter in which preferred embodiments of the invention are illustrated and described by way of example only.

### BRIEF DESCRIPTION OF THE DRAWINGS

FIG. 1 shows a schematic diagram showing a typical bi-directional WDM point to point network according to the prior art;

FIG. 2 illustrates a lower frequency pilot tone superimposed onto a non-return-to-zero (NRZ) data stream according to the prior art;

FIG. 3 shows a schematic of a network comprising two different fibre types showing two examples of different routes through the network;

FIG. 4 shows an optical supervisory channel (OSC) associated with a WDM C band spectrum;

FIG. 5 shows a schematic of a co-propagating OSC with a WDM system in accordance with an embodiment of the present invention;

FIG. 6 shows a schematic illustrating how the pilot tone is combined with an OSC in accordance with an embodiment of the present invention;

FIG. 7 shows a schematic of a WDM wavelength when switched between different routes and links on a network and the different pilot tone frequencies generated in each link in accordance with an embodiment of the present invention;

FIG. 8 shows a schematic of a network in accordance with an embodiment of the present invention; and

FIG. 9 shows a flow diagram of a method in accordance with an embodiment of the present invention.

### DETAILED DESCRIPTION

Below is described a preferred embodiment of an apparatus and method for identifying a characteristic of a mesh network. In the following description, numerous specific details are set forth in order to provide a thorough understanding of the embodiments of the present invention. It will be clear, however, to those skilled in the art that the present invention may be practiced without particular specific details.

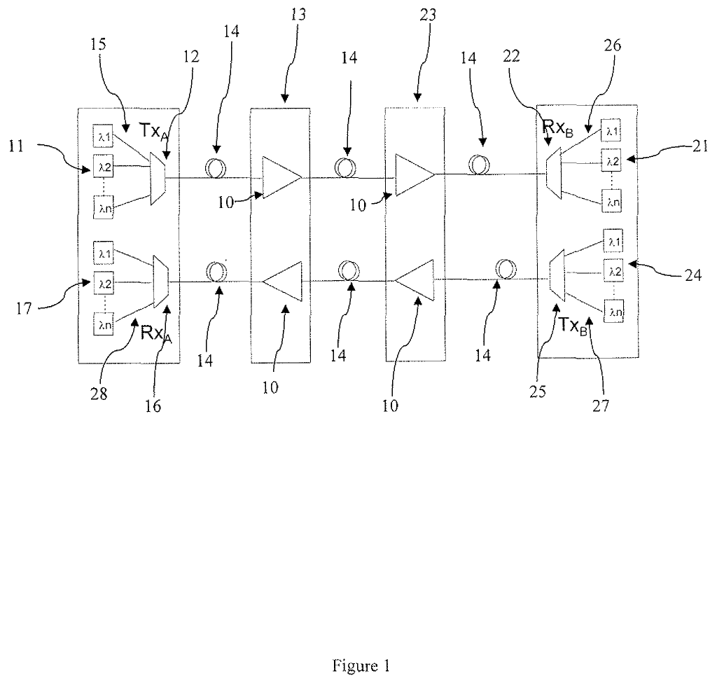

WDM systems are typically all-optical in nature, and often simply transmit bulk traffic from one point to another. FIG. 1 (prior art) shows a typical WDM system which consists of a transmit (Tx) terminal node 15, 27 where the individual wavelengths of light 11, 24 (optical data channels) are modulated with the operator's traffic (data), multiplexed by multiplexers 12, 25 together (for example using an arrayed waveguide grating) and launched into the transmission fibre span 14. In the amplifier(s) 13, 23, the multiplex of channels are all boosted in power together in order to account for fibre attenuation. The amplification is typically provided by erbium doped fibre amplifiers (EDFAs) 10. At these points, dispersion compensation may be provided to account for the effects of fibre chromatic dispersion. Both the amplification and dispersion compensation maintain the channel multiplex in the optical domain, which proves cost effective as only one amplifier 10 or dispersion compensation module (DCM) can be used to amplify or dispersion compensate for all of the channels together. At the receive (Rx) terminal node 26, 28, the incoming multiplex of channels is split (demultiplexed) 22, 16 into its constituent optical wavelengths 17, 21, and an individual photodiode used to convert each wavelength's data into the electrical domain for processing by the operator.

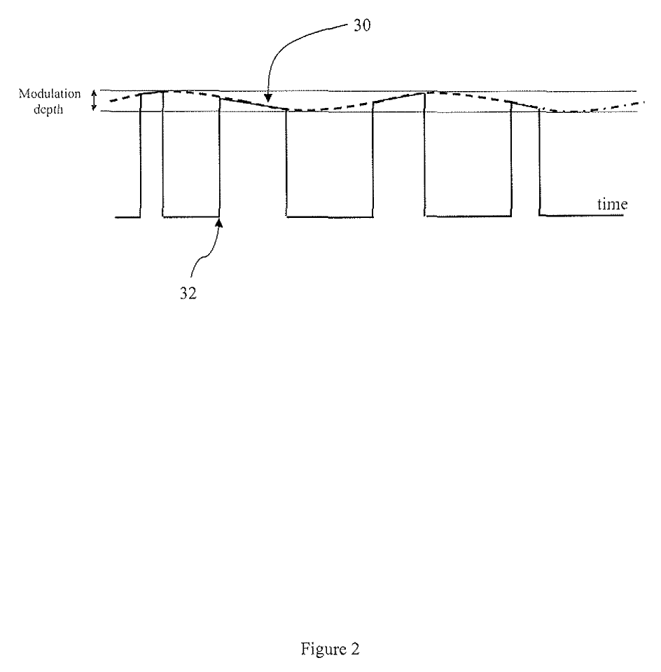

Techniques used for path monitoring in WDM systems, have used pilot tones 30 to identify individual wavelengths within the WDM system. In telecommunications, a pilot tone 30 is a signal, usually a single frequency, transmitted over a communications system for supervisory, control, equalization, continuity, synchronization, or reference purposes. FIG. 2 shows a pilot tone 30 modulated onto a non-return-to-zero (NRZ) data stream 32. In this example the 10 Gb/s data stream 32 has a 100 kHz pilot tone 30 superimposed upon it. Normally the pilot tone 30 would be a much lower frequency compared with the data stream 32.

Pilot tones 30 are effective for a) identifying individual wavelengths and b) identifying starting nodes of a particular route. This is however the limit of the technique as currently described because of the restrictions imposed by existing methods of transferring the pilot tone 30 onto the individual wavelengths. The present inventors have appreciated that he prior art does not provide a cost effective technique for a) transferring a pilot tone 30 to all wavelengths on a particular optical link 14—and as a consequence of this; b) There exists no technique for all-optically monitoring the entire route history of a particular wavelength channel (e.g. optical links consisting of terminal nodes, amplifier nodes and add/drop nodes) and finally, c) the prior art does not allow a non-traffic affecting upgrade to existing systems.

The present invention provides an apparatus and method of identifying a characteristic of an optical link in an optical network. By modulating a predetermined optical channel (such as an Optical Supervisory Channel) with a predetermined frequency component (e.g. a pilot tone), and then transmitting the modulated signal onto an optical waveguide at a predetermined power provides the basis for identifying individual wavelengths. By then taking this modulated signal and co-propagating it with the optical data channel along an optical waveguide the optical channel is modulated with the predetermined frequency component and provides a method of identifying a characteristic of an optical link which is an all-optical process. By identifying we mean that a label or some form of identification for identifying a particular optical link in an optical network is provided to the optical data channel(s). Such identification (which here takes the form of a frequency component) can later be detected or measure, and hence the link(s) traversed by the optical data channel(s) may later be determined from the identification/label.

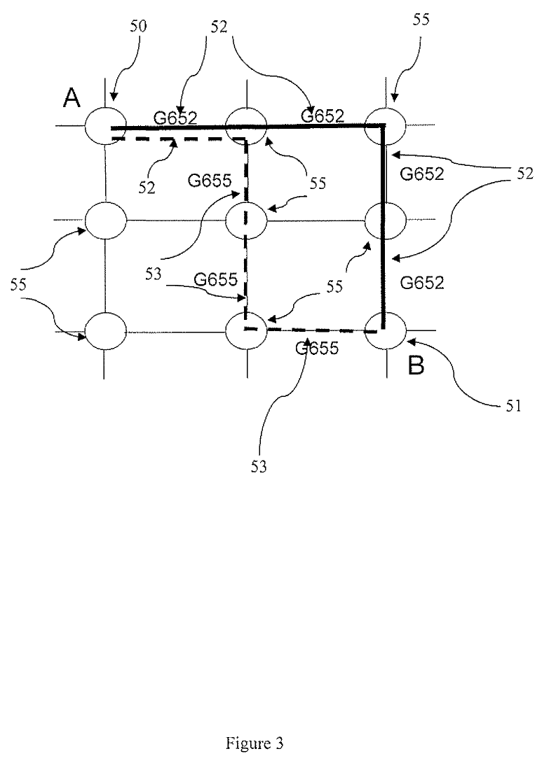

FIG. 3 displays an example of an optical mesh network, where instead of purely transmitting point-to-point WDM data (as in FIG. 1), each node 50, 51, 55 in the network is able to transmit any wavelength to a choice of (in this case) three other directions for any particular incoming signal. If we consider the particular case where there are just two different fibre types within the network—G652 (52) and G655 (53)—an example of two different routes through the network is shown starting from node A (50) and ending at node B (51). Route 1 takes the WDM signal through 4×G652 links (52) of fibre and Route 2 takes the signal through 1×G652 (52) and 3×G655 links (53).

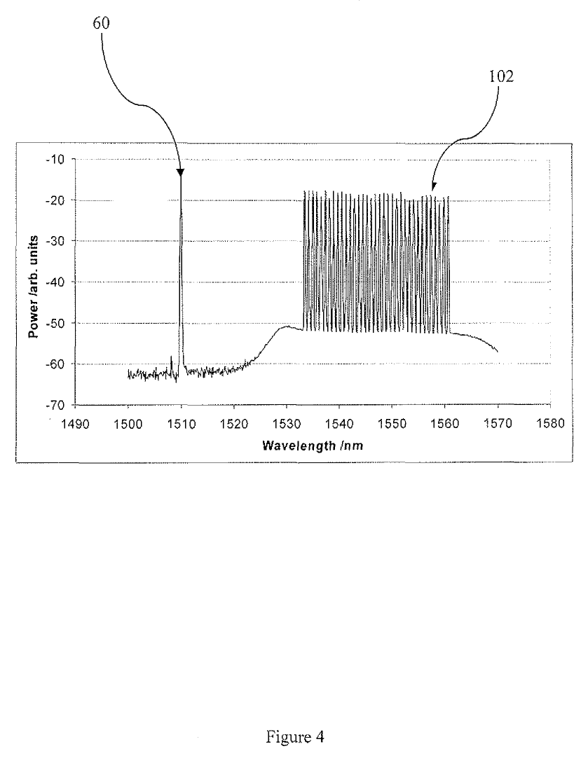

FIG. 4 shows an optical supervisory channel 60 associated with a WDM C band 102 data stream. The Optical Supervisory Channel (OSC) 60 is transmitted by a low cost, low bit-rate, directly modulated laser. Typical WDM optical communication systems use multiple optical supervisory channels (OSCs) 60 to achieve management of the line equipment e.g. one OSC per link. The OSCs 60 carry management information, such as alarms and provisioning information, to and from the transmission line elements to a network management system. Many optical communication systems create the OSCs 60 using a separate “out of band” transceiver system with a transmitter wavelength that is typically at 1510 nm which is used with conventional WDM C Band 102 of 1530-1565 nm as shown in FIG. 4. This means that there is a wavelength separation between the predetermined optical channel (OSC) 60 and the optical data channel 102 of between 90 nm to 100 nm.

The present inventors have appreciated that the utility of predetermined optical channels such as OSCs can be enhanced. In particular, in a preferred embodiment of the invention an OSC is modulated with a predetermined frequency component at a sufficient power such the optical data channels co-propagating along the optical waveguide of a link with the modulated predetermined optical channel (70) will each be modulated with the predetermined frequency component. Thus, the OSC can be used to impart a label (in the form of the frequency component) to the optical data channels.

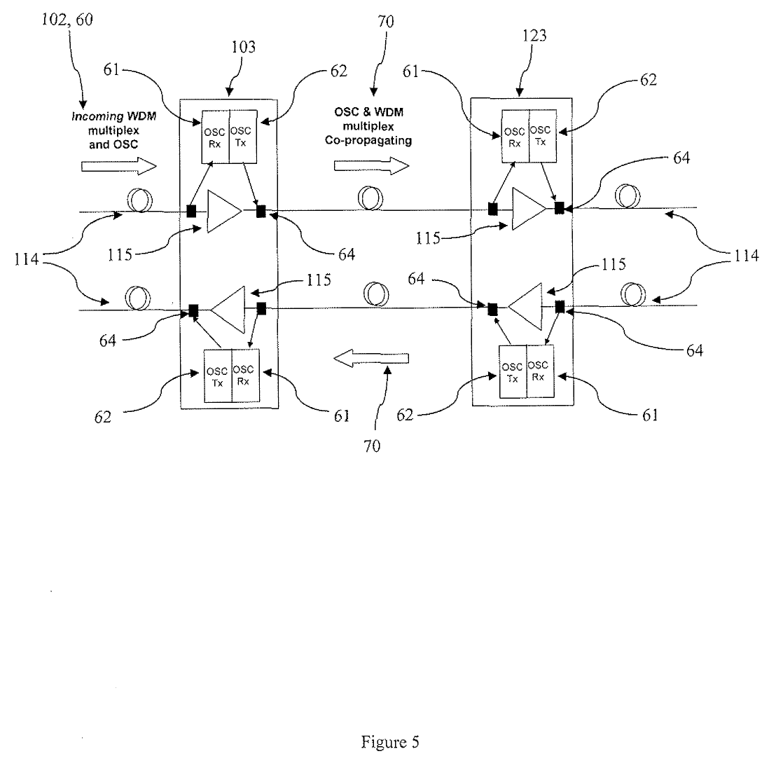

FIG. 5 shows the circuitry used in transmitting the combined and modulated predetermined optical channel 70 and the WDM 102 data stream. The OSC laser 82 is coupled onto the same transmission fibre link 114 as the WDM multiplex using a commonly available thin-film WDM filter. The combined signal 70 can either be transmitted in a co-propagating or counter-propagating manner. Preferably, the modulated predetermined optical channel 70 is co-propagating with the multiplex data stream 102 as displayed in FIG. 5. This allows the pilot tone 40 to be transferred efficiently from the modulated predetermined optical channel 70 to the WDM multiplex data stream 102. Also, in order for efficient transfer to occur the modulated predetermined optical channel 70 should be transmitted at a power in the range of 3 dBm to 10 dBm and preferably at a power of at least 5 dBm.

FIG. 5 also shows the co-propagating modulated predetermined optical channel 70 architecture within a WDM system. The transmission of an optical supervisory channel (OSC) 60 is typically at 1510 nm and the WDM data stream 102 is generally transmitted in a band of 1530-1565 nm. Since the OSC 60 channel cannot be amplified using EDFA technology, and Raman gain at this wavelength is less than for C-band signal channels, special methods can be used to allow the OSC 60 to be transmitted 300 across long spans. Such techniques may include amplifying the OSC 60 using semiconductor optical amplifier technology or placing the OSC 60 within the C-band 102. In FIG. 5 the incoming WDM multiplex data stream and the OSC 102, 60 signals are transmitted on the fibre link 114. The OSC 60 signal and the WDM data stream 102 are split/combined by a splitter/combiner 64 for amplification at the nodes 103, 123. The OSC 60 is amplified by the oscillator Rx/Tx 61, 62 and the WDM data stream 102 is amplified by the optical amplifier 115. The amplification is typically provided by erbium doped fibre amplifiers (EDFAs) 115 or Raman amplification. The combined signal 70 is then transmitted on fibre link 114 in a co-propagating manner.

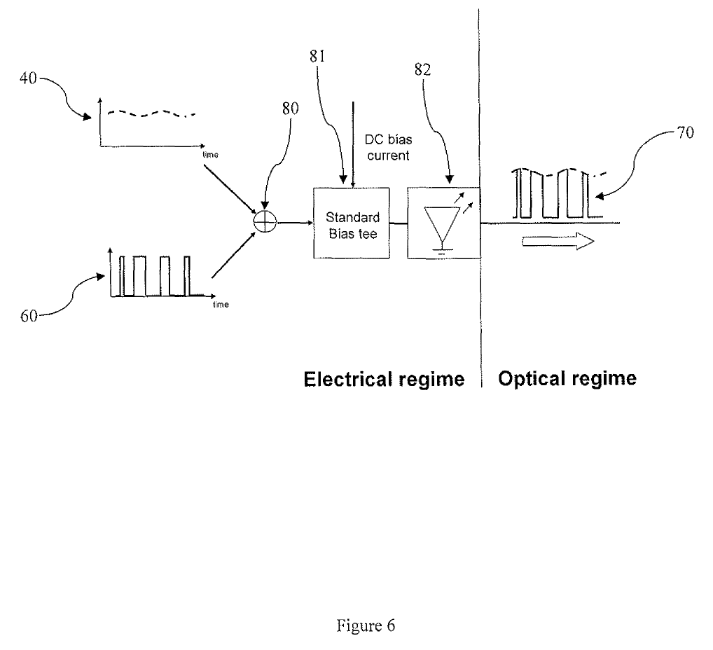

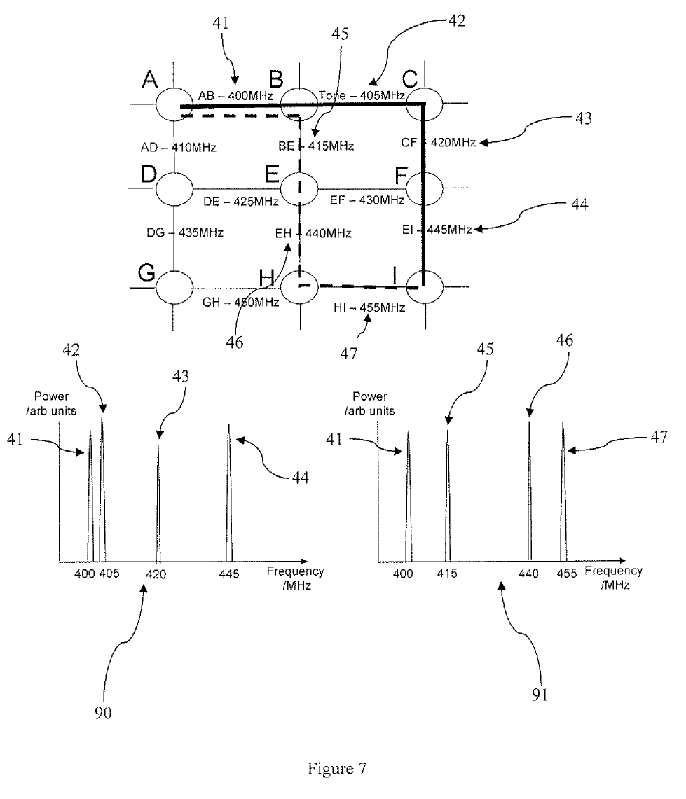

A voltage controlled oscillator can be used for the physical addition of the pilot tone 40 to the OSC 60 laser output as shown in FIG. 6. The OSC 60 laser is already directly modulated at a fixed bit rate between 1-10 Mb/s (often 2 Mb/s) in order to fulfill its normal functionality. In addition to the circuitry required to do this, the pilot tone 40 may be generated via a Voltage Controlled Oscillator (VCO) (not shown) and electrically added 80 to the standard OSC 60 data signal—the combined modulated predetermined optical channel 70 signal is then used to drive the OSC laser 82, by modulating 81 the drive current to the OSC laser 82. The frequency of the VCO can be tuneable or preferably settable by a software interface so that unique pilot tone frequencies can be set to reflect each link 114 as shown in FIG. 7 which is discussed in further detail below. FIG. 6 shows a schematic illustrating the modulation principle described above were the OSC 60 is modulated with the predetermined frequency component or pilot tone 40 to produce the modulated predetermined optical channel 70. The modulation process in this case is amplitude modulation, however, any form of modulation which allows the OSC 60 to be modulated with the predetermined frequency component or pilot tone 40 to produce the modulated predetermined optical channel 70 can be used.

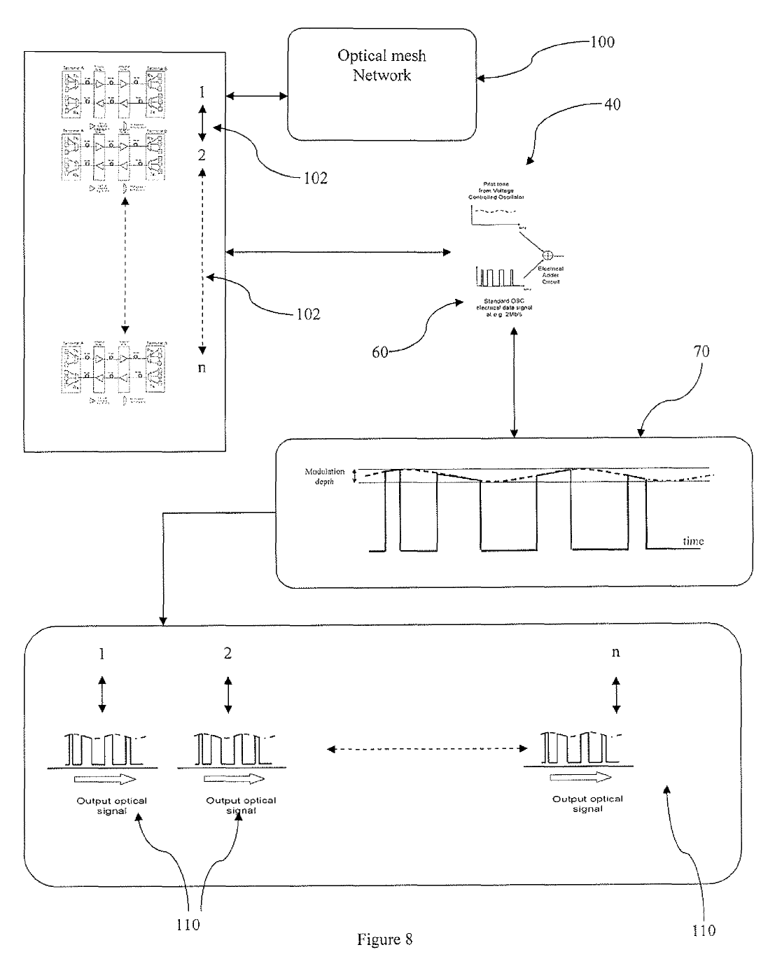

As described above a predetermined optical channel (Optical Supervisory Channel) is modulated with a predetermined frequency component (a pilot tone), and is then transmitted onto an optical waveguide at a predetermined power, this provides the basis for identifying individual wavelengths. FIGS. 7 and 8 show a block diagram of the apparatus and the resultant pilot tones produced to identify the characteristic(s) of a mesh network 100 when the modulated predetermined optical channel 70 and pilot tones 40 are modulated with the optical data channel 102.

In order to identify the fibre links 114 within an optical mesh network the pilot tone 40 is modulated and transferred from the OSC 60 to the WDM channels 102. The link-identifying pilot tone 40 is modulated to each of the WDM channels 102 via the physical process of Stimulated Raman Scattering (SRS). Raman scattering is a photonic phenomenon found particularly readily within optical fibre. The process may provide optical gain to high wavelength channels from a lower wavelength, higher energy pump. The modulation in this case is amplitude modulation, however other types of modulation may be used.

In the embodiment utilising SRS, a ‘signal’ photon from within the WDM multiplex 102 induces the inelastic scattering of a photon from the OSC ‘pump’ laser 82 which is of high enough power to be operating in the required nonlinear regime. As a result of this, another signal photon is produced with the surplus energy resonantly passed to the vibrational states of the medium. In effect, the OSC laser 82 can provide gain to the WDM multiplex 102. A corollary of this is that any modulation on the OSC pump 82 will accordingly modulate the gain offered to the WDM multiplex 102. Hence a transfer of the pilot tone 40 to the WDM multiplex 102 is achieved and the resultant signal 110 is transmitted on the optical link 114.

Stimulated Raman Scattering is a highly rapid physical effect and will transfer any modulation from the OSC pump 82 to the signal almost instantaneously. In order to ensure efficient transfer the OSC 60 wavelength range and the peak power should be taken into consideration. The launch power and wavelength of the OSC channel 60 into each fibre span/link 114 is important in producing efficient transference of the pilot tone 40 into the full WDM multiplex 102. Peak Raman gain (and hence peak tone transfer efficiency) occurs most efficiently in single mode fibre at a pump/signal frequency differential of 11-13 THz (˜90 −100 nm). Therefore, for maximum pilot tone 40 transfer in the centre of the C-band (1545 nm) 102, the optimum OSC laser 82 wavelength is ˜1450 nm. This embodiment of the present invention will still function however, with the OSC 60 at any wavelength value between 1430 nm and 1510 nm (standard OSC wavelength) at the expense of less efficient pilot tone 40 transfer at the relevant edge of the C-band 102. For a 1510 nm OSC 60, the least efficient edge of the C-band 102 would be at 1530 nm. For a 1430 nm OSC 60, the least efficient edge would be 1565 nm.

The OSC 60 launch power should be of a high enough value to cause adequate pilot tone 40 transfer for detection. It has been found experimentally that for G652 fibre, the peak OSC 60 launch power should be at least 5 dBm to visibly transfer to the WDM C-band 102 at a modulation index of 10% (ratio of pilot tone 40 to OSC 60 data amplitude) to produce a transmitted signal 110. This data was obtained with a 1510 nm OSC laser 82, and the least efficient WDM channel 102 available of 1529.6 nm. The upper limit for peak OSC 60 power is caused by the degradation of the WDM signal 102 via patterning from the OSC 60 data itself. The peak OSC 60 power should therefore be balanced at a point where the transferred pilot tone 40 peaks are detectable, but the modulation index of the transferred standard OSC 60 data on the WDM signals 102 is not sufficient to cause decreased bit error rate (BER) transmission performance. Experiments have shown that +9±1 dBm OSC 60 power launched into the fibre is a good compromise for G652 fibre, but this power will vary for different fibre types and thus should be user-adjustable. This is straightforward, as OSC 60 distributed feedback lasers 82 routinely offer in excess of 13 dBm output power.

The frequency of the pilot tone 40 is also important to ensure efficient transfer of the pilot tone 40 to the WDM signal 102. In this embodiment, for optimum performance it is the frequency of the pilot tone 40 which is important and not the amplitude of the pilot tone 40, and hence restricting the appearance of ‘ghost channels’ from EDFA carrier lifetime effects at low (<100 kHz) frequencies is an important consideration. Preferably, the frequency is greater than 10 MHz, to avoid unwanted gain modulation in the optical amplifiers. The frequency is more preferably within a range of 400 MHz to 600 MHz, however a range of 200 MHz to 700 MHz could also be utilised.

FIG. 7 shows a schematic of the operation of a WDM wavelength when switched between different routes of different lengths. FIG. 7 shows how different pilot tone frequencies 40 are picked up by a WDM channel that is switched between two different routes. The different frequency pilot tone signals 90, 91 give an exact description of all the optical links 114 that the signal has been transmitted through and therefore provides a route history of a channel within a reconfigurable WDM network which is continually monitored by the application of the low frequency pilot tone 40 to all the data channels 102 on a particular optical link 114. This information can hence be assimilated at the final receive terminal and used for whatever compensation scheme (e.g. dispersion) requires it.

For example the pilot tone signal 90 is produced with the pilot tone frequencies at 41, 42, 43, and 44 which reflects the route of moving from nodes A to B to C to F and finally to I. Likewise, the pilot tone signal 91 is produced with the pilot tone frequencies at 41, 45, 46, and 47 which reflects the route of moving from nodes A to B to E to H and finally to I. In the example shown in FIG. 7, the pilot tone frequencies are as follows—41=400 MHz, 42=405 MHz, 43=420 MHz, 44=445 MHz, 45=415 MHz, 46=440 MHz and 47=455 MHz.

Each or any node A-I can include apparatus for determining the route history. In the example shown in FIG. 7, at least node I (the destination node) includes a receiver for receiving the optical data channel(s). The node I also includes measurement apparatus for measuring the frequency component(s) that have been modulated onto the received optical data(s).

In this example, this measurement apparatus comprises a separator (such as a low pass filter) for separating the frequency component(s) from the higher frequency data transmitted by the data channel. The separator is coupled to a detector for detecting/measuring the frequency components. The output of the detector is coupled to a processor for processing of the information regarding the optical links from the measured frequency component(s), as appropriate. For example, the processor may be configured to explicitly identify the individual optical links, or to simply determine the relevant properties (e.g. fibre type, dispersion characteristics or attenuation characteristics) of the optical links traversed by each data channel, from the measured frequency component(s),

An embodiment of the present invention may be implemented within an optical network by a suitable apparatus as described below and in FIG. 8. The apparatus for identifying a characteristic (or route history) of an optical link 114 within an optical network 100 comprises a modulator for modulating a predetermined optical channel 60 (OSC) with a predetermined frequency component 40. In this case the modulation used is amplitude modulation (AM), however any other technique used for transmitting information within electronic communications may be used.

The modulated predetermined optical channel 70 is then transmitted by a suitable coupler onto an optical waveguide of an optical link 114 at a predetermined power such that the optical data channel 102 co-propagating along the optical waveguide with the modulated predetermined optical channel 70 is modulated with the frequency component 40. An optical mesh network 100 consisting of 1 to n wavelengths 102 are modulated using the physical process of stimulated Raman scattering. The different frequency pilot tone signals 90, 91 give an exact description of all the optical links 114 that the signal has been transmitted through and therefore provides a route history of a channel within a reconfigurable WDM network which is continually monitored by the application of the low frequency pilot tones 40 to all the data channels 102 on a particular optical link 114.

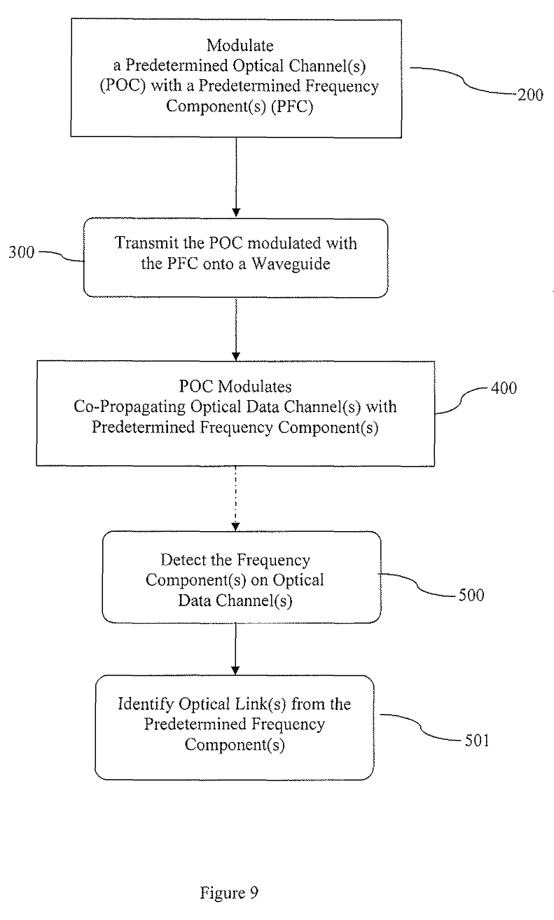

FIG. 9 shows a flow chart representing the method involved in identifying 501 a characteristic(s) of an optical link 114 of an optical network 100. By modulating 200 a predetermined optical channel 60 such as an optical supervisory channel with a predetermined frequency component 40 such as a pilot tone and then transmitting 300 the modulated signal 70 onto an optical waveguide of an optical link 114 such that a co-propagating optical data channel 102 is modulated 400 with the predetermined frequency component 40 to transfer the pilot tones 40 to the optical data channel 102.

Typically, each link will have associated with it a respective frequency component. Each link may be associated with a different frequency component. Each type of link may bee associated with a different frequency component e.g. a frequency component may be associated with a type of fibre or a particular apparatus.

Each link can have a respective OSC, imparting a respective frequency (or set of frequencies) to the data channels transmitted along that link. Thus, as each optical data channel is transmitted along a respective route through the network, it will be transmitted along different links, and hence become modulated with the frequency component(s) from each link. The route of an optical data channel can thus be determined or identified 501 by measuring the frequency components 500 that have been imparted to the data channel. This route detection can be performed at the destination node, or at any intermediate node of the network at which it may be desirable to know the route history of a channel e.g. for compensating for performance impairments to the channel as it has been transmitted along the different links.

Any reconfiguration of a channel's route through the optical network 100 will immediately update the set of pilot tone frequencies 90, 91 for that channel with no processing delays associated with possible electronic/software solutions.

Therefore this embodiment of the present invention provides both an apparatus and method for identifying a characteristic 501 of a mesh network 100 as shown in FIGS. 7 to 9. In the present embodiment the characteristic 501 may be any one of the optical link 114, an add/drop node coupled to the optical link 114 or any variable which is changeable on a channel link 114 basis through which the optical data channel 102 propagates. A network will consist of a number of optical data channels 102 which are modulated 400 with a predetermined frequency component 40. An example of such a network would be an 80 wavelength system having the potential to be sent through highly varied routes of the optical mesh network 100, seeing different fibre types

The route history and as such the transmitted signal 110 of a channel within a reconfigurable WDM network 100 is continually monitored by the application of a low frequency pilot tone 40 to all the data channels 102 on a particular optical link 114. The application of the pilot tone 40 is achieved using the technique of stimulated Raman scattering from a separate out-of-band, low-cost modulated laser channel (e.g. an existing optical supervisory channel). As the data signals are spatially switched at subsequent nodes, new pilot tones 40 at different frequencies can be added via this technique corresponding to the new links 114 that are passed through.

In a further advantage of this technique, any subsequent nodes can now be purely amplifying nodes 115. Finally, at the terminating node the pilot tones 40 can all be simultaneously detected in real time and hence ‘on the fly’ knowledge of all the previous links 114 obtained. The technique is non traffic-affecting and could be retroactively employed to existing networks without disturbance.

Although the present invention has been illustrated and described with respect to exemplary embodiments thereof, it should be understood by those skilled in the art that the foregoing and various other changes, omission and additions may be made therein and thereto, without departing from the scope of the invention. For example, apparatus may be configured to perform any of the described method steps, and vice versa. Therefore the present invention should not be understood as limited to the specific embodiment set out above but to include all possible embodiments which can be embodied within a scope encompassed and equivalent thereof with respect to the features set out in the appended claims.

1. A method for identifying at least one characteristic of at least one optical link of an optical network, the method comprising:
modulating a predetermined optical channel with a predetermined frequency component; and
transmitting the modulated predetermined optical channel onto an optical waveguide of an optical link at a predetermined power such that at least one optical data channel co-propagating along the optical waveguide with the modulated predetermined optical channel is modulated with the predetermined frequency component.

2. The method according to claim 1, wherein the at least one optical data channel is modulated with the predetermined frequency component by the physical process of stimulated Raman scattering.

3. The method according to claim 1, wherein said at least one optical data channel further comprises a plurality of optical data channels, each one of the plurality of optical data channels being modulated with the predetermined frequency component.

4. The method according to claim 1, wherein the predetermined frequency component is indicative of the identity of at least one of: the optical link; an add/drop node coupled to said optical link; and an optical element coupled to said optical link, through which the at least one optical data channel propagates.

5. The method according to claim 1, wherein the network comprises a plurality of optical links, the method comprising repeating said modulating and transmitting steps for each of said plurality of optical links, with each optical data channel being modulated with a different predetermined frequency component for each optical link.

6. The method according to claim 1, wherein the frequency of each predetermined frequency component is within the range of 400 MHz to 600 MHz.

7. The method according to claim 1, wherein said optical data channel is modulated with the predetermined frequency component by amplitude modulation.

8. The method according to claim 1, wherein said predetermined optical channel is an optical supervisory channel for carrying supervisory information.

9. The method according to claim 1, wherein a wavelength separation between said predetermined optical channel and the at least one optical data channel is within the range of 90 nm to 100 nm.

10. The method according to claim 1, wherein the predetermined optical channel is transmitted at a power of at least 5 dBm.

11. The method according to claim 1, wherein said optical waveguide is an optical transmission fibre extending between two nodes of said network.

12. A method according to claim 1, further comprising:
receiving at least one optical data channel; and
measuring at least one predetermined frequency component modulating the received at least one optical data channel for determining the route history of said at least one optical data channel.

13. An apparatus for an optical network for identifying at least one characteristic of at least one optical link of an optical network, the apparatus comprising:
a modulator for modulating a predetermined optical channel with a predetermined frequency component; and
a coupler for transmitting the modulated predetermined optical channel onto an optical waveguide of an optical link at a predetermined power such that at least one optical data channel co-propagating along said optical waveguide with the modulated predetermined optical channel is modulated with said frequency component.

14. The apparatus according to claim 13, wherein the modulator is tuneable to provide a different predetermined frequency component for different optical links.

15. The apparatus according to claim 13, wherein the frequency of the predetermined frequency component is within the range of 400 MHz to 600 MHz.

16. The apparatus according to claim 13, wherein the predetermined optical channel is an optical supervisory channel for carrying supervisory information.

17. The apparatus according to claim 13, wherein a wavelength separation between said predetermined optical channel and the at least one optical data channel is within the range of 90 nm to 100 nm.

18. The apparatus according to claim 13, further comprising a generator arranged to generate the predetermined optical channel at a power of at least 5 dBm.

19. A receiver arranged to receive at least one optical data channel; and
measure at least one predetermined frequency component modulating the received at least one optical data channel for determining the route history of said at least one optical data channel.
